(19) United States
(12) Patent Application Publication
(10) Pub. No.: US 2011/0234800 A1
(43) Pub. Date: Sep. 29, 2011

(54) IMAGE PROCESSING DEVICE AND IMAGE PROCESSING SYSTEM

(75) Inventor: Setsuo Terasaki, Yokohama-shi (JP)

(73) Assignee: KABUSHIKI KAISHA TOSHIBA, Tokyo (JP)

(21) Appl. No.: 13/029,646

(22) Filed: Feb. 17, 2011

(30) Foreign Application Priority Data
Mar. 23, 2010 (JP) 2010-66162

(51) Int. Cl. H04N 5/04; H04N 7/18

(52) U.S. Cl. 348/148; 348/500; 348/E05.009; 348/E07.085

(57) ABSTRACT

According to one embodiment, an image processing device includes a control signal generator, a selector, a memory, and a combined image generator. The control signal generator is configured to detect a synchronization pulse from a vertical synchronization signal in each of a plurality of video signals and configured to generate a first control signal indicative of selecting one video signal of the plurality of video signals of which the synchronization pulse is detected in turn for a predetermined period. The selector is configured to select the one video signal of the plurality of video signals according to the first control signal. The memory is configured to store the selected video signal in one region of a plurality of regions corresponding to the selected video signal in a predetermined format. The combined image generator is configured to generate a combined image by combining the plurality of video signals stored in the plurality of regions.

### CROSS REFERENCE TO RELATED APPLICATIONS

This application is based upon and claims the benefit of priority from the prior Japanese Patent Application No. 2010-66162, filed on Mar. 23, 2010, the entire contents of which are incorporated herein by reference.

### FIELD

Embodiments described herein relate generally to an image processing device and an image processing system.

### BACKGROUND

There has been proposed a vehicle system which generates an overhead view image capable of looking around a vehicle and displays the overhead view image on a display in the vehicle. The overhead view image is obtained by converting each of video signals taken by four cameras, which are attached on a front, a rear, a left side, and a right side of the vehicle respectively, to an image seen from upside of the vehicle to combining them (JP-A No. 2007-336230 (Kokai), hereinafter, “Patent Document 1”). A driver of the vehicle can put the vehicle into a garage safely while watching the display, for example.

The vehicle system of Patent Document 1 has four image decoders and four image memories, each of which corresponds each of four cameras. The image decoders convert the video signals inputted from the cameras to a predetermined format, and the image memories store the converted images. Then, the overhead view image is generated by combining the images stored in the image memories.

However, there is a problem that the vehicle system may be costly because the technique described in Patent Document 1 needs four image decoders and four image memories.

### BRIEF DESCRIPTION OF THE DRAWINGS

FIG. 1 is a block diagram showing a schematic configuration of an image processing system according to a first embodiment.

FIG. 2 is the cameras la to ld attached on a vehicle 50.

FIG. 3 is a timing chart showing an example of the video signals 11a to 11d, the vertical synchronization signals VsyncA to VsyncD, the control signal 2s and the selected video signal 12.

FIG. 4 is a flowchart showing an example of the processing operation of the control signal generator 82.

FIG. 5 is a timing chart showing an example of the video signals 11a to 11d and the selected video signal 12 when the controller 8 is not provided.

FIG. 6 is a timing chart showing an example of the video signals 11a to 11d, the vertical synchronization signals VsyncA to VsyncD, the control signal 2s and the selected video signal 12.

FIG. 7 is a flowchart showing an example of the processing operation of the control signal generator 82.

FIG. 8 is a timing chart showing another example of the video signals 11a to 11d and the selected video signal 12.

FIG. 9 is a flowchart showing an example of the processing operation of the control signal generator 82.

FIG. 10 is a schematic configuration showing an example of an internal configuration of the control signal generator 82.

FIG. 11 is a circuit block diagram showing an example of the more detailed internal configuration of the control signal generator 82.

FIG. 12 is a schematic diagram showing an example of an internal configuration of the selector 2.

FIG. 13 is a timing chart showing signal waveforms of each part of the selector 2 and the control signal generator 82.

FIG. 14 is a timing chart showing an example of the video signals 11a to 11d, the control signal 2s and the selected video signal 12.

FIG. 15 is a flowchart showing an example of the processing operation of the control signal generator 82.

### DETAILED DESCRIPTION

In general, according to one embodiment, an image processing device includes a control signal generator, a selector, a memory, and a combined image generator. The control signal generator is configured to detect a synchronization pulse from a vertical synchronization signal in each of a plurality of video signals and configured to generate a first control signal indicative of selecting one video signal of the plurality of video signals of which the synchronization pulse is detected in turn for a predetermined period. The selector is configured to select the one video signal of the plurality of video signals according to the first control signal. The memory is configured to store the selected video signal in one region of a plurality of regions corresponding to the selected video signal in a predetermined format. The combined image generator is configured to generate a combined image by combining the plurality of video signals stored in the plurality of regions.

Embodiments will now be explained with reference to the accompanying drawings.

### First Embodiment

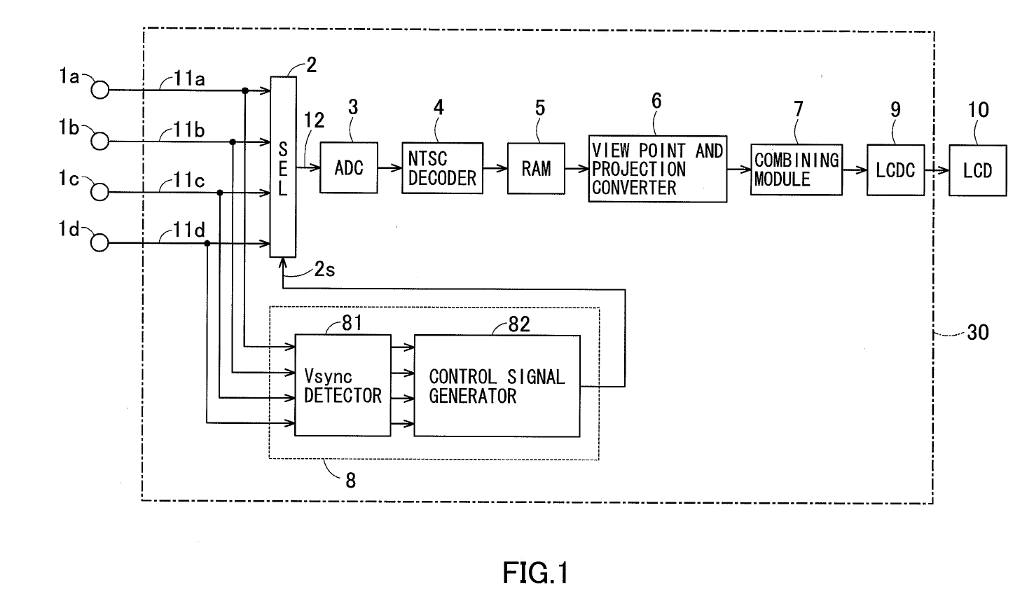

FIG. 1 is a block diagram showing a schematic configuration of an image processing system according to a first embodiment. The image processing system of FIG. 1 has four cameras 1a to 1d, an image processing device 30, and a liquid crystal display (LCD, display) 10.

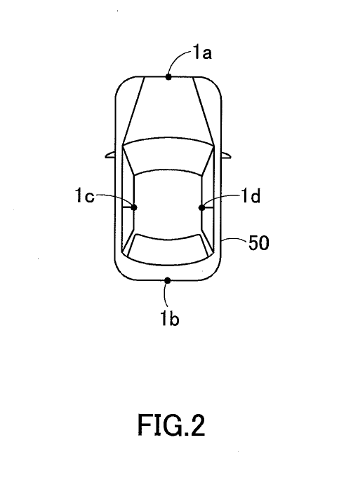

FIG. 2 is the cameras la to ld attached on a vehicle 50. As shown in FIG. 2, the cameras 1a to 1d are attached on a front, a rear, a left side, and a right side of the vehicle, respectively. The cameras 1a to 1d output analog video signals 11a to 11d, respectively. The video signals 11a to 11d are, for example, composite video signals on which a vertical synchronization signal and an image data composed of a luminance signal Y and color different signals Cb, Cr are superimposed. The cameras 1a to 1d are asynchronous cameras. Therefore, the cameras 1a to 1d do not operate in synchronization with each other, and phases of the vertical synchronization signals are not synchronized.

The image processing device 30 of FIG. 1 has a selector (SEL) 2, an analog to digital converter (ADC) 3, an NTSC decoder 4, a RAM (memory) 5, a viewpoint and projection converter 6, a combining module 7, a controller 8, and an LCD controller (LCDC) 9. The image processing device 30 combines the images taken by the four cameras 1a to 1d to generate an overhead view image and displays it on the LCD 10.

The selector 2 selects one of the video signals 11a to 11d according to a control signal (first control signal) to output it as a selected video signal 12. The analog to digital converter 3 converts the selected video signal 12 to a digital signal. The NTSC decoder 4 converts the video signal to a video signal which meets an NTSC (National Television Standard Committee) format. Furthermore, the NTSC decoder 4 may add a camera identifying data indicative of from which camera the video signal is inputted during a horizontal blanking period of the converted video signal according to the control signal 2s.

The RAM 5 has a plurality of areas and stores the four video signals inputted from the four cameras in the corresponding areas, respectively. When a new video signal is inputted through the selector 2, the analog to digital converter 3 and the NTSC decoder 4, only the new video signal is updated among the four video signals stored in the RAM 5. Which camera the selected video signal 12 corresponds to can be determined based on the control signal 2s or the camera identifying data.

Because the selector 2 selects one of the video signals 11a to 11d, the image processing device 30 has only one analog to digital converter 3, NTSC decoder 4 and RAM 5, respectively.

The viewpoint and projection converter 6 converts the four video signals stored in the RAM 5 to video signals projected into a ground from upside of the vehicle 50, for example, by an affine transformation. The combining module 7 combines the projected four video signals to generate the overhead view image (combined image). A combined image generator has the viewpoint and projection converter 6 and the combining module 7.

The controller 8 has a vertical synchronization signal detector (Vsync detector) 81 and a control signal generator 82. The vertical synchronization signal detector 81 detects vertical synchronization signals VsyncA to VsyncD superimposed on the video signals 11a to 11d, respectively. The control signal generator 82 detects synchronization pulse from the vertical synchronization signals VsyncA to VsyncD and generates the control signal 2s so that the video signals 11a to 11d are selected in order that the synchronization pulse is detected.

The controller 8 can be implemented by software or by hardware. One of characteristic features of the present embodiment is the controller 8, and the processing operation thereof will be described below.

The LCD controller 9 converts the overhead view image to a signal for displaying the LCD 10 to drive the LCD 10. The LCD 10 is provided on a position easily seen by a driver in the vehicle 50 of FIG. 2 to display the generated overhead view image.

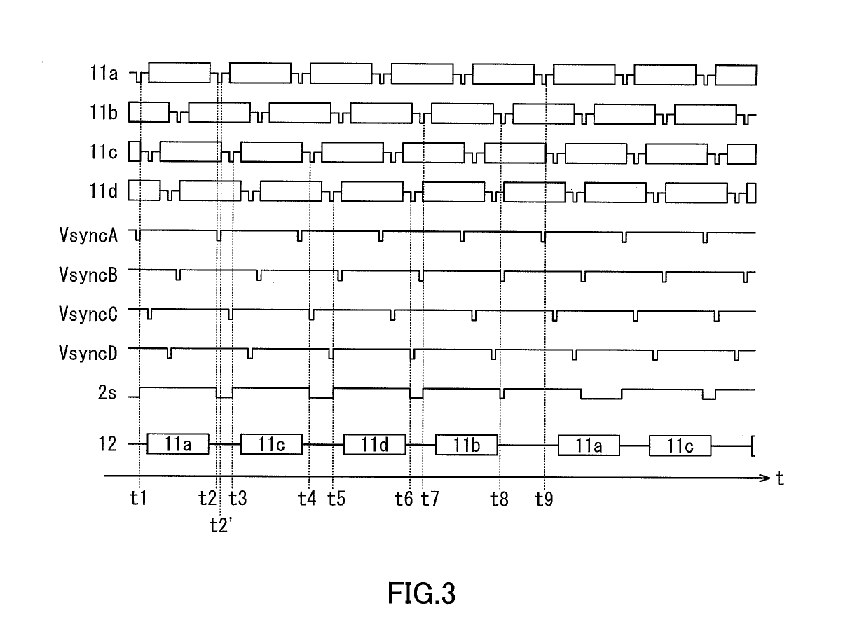

FIG. 3 is a timing chart showing an example of the video signals 11a to 11d, the vertical synchronization signals VsyncA to VsyncD, the control signal 2s and the selected video signal 12. The video signals 11a to 11d have image data inserted between the synchronization pulses. More specifically, low pulses (negative-polarity pulse) are the synchronization pulses of 60 Hz, for example, and the image data (the luminance signal Y and the color difference signals Cb, Cr, in the present embodiment) of a field corresponding to an odd line or an even line is inserted between the synchronization pulses. The vertical synchronization signal detector 81 separates the vertical synchronization signals VsyncA to VsyncD from the video signals 11a to 11d respectively to provide them to the control signal generator 82. Because the cameras 1a to 1d are asynchronous cameras, timing when the synchronization pulses are generated in the vertical synchronization signals VsyncA to VsyncD is not synchronized.

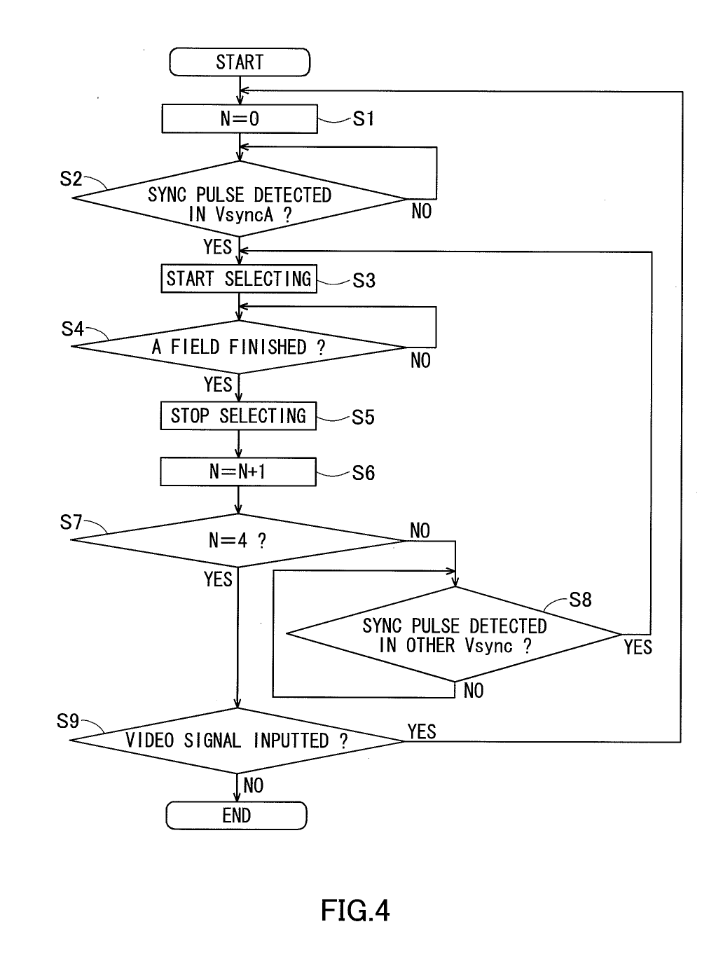

FIG. 4 is a flowchart showing an example of the processing operation of the control signal generator 82. FIG. 4 shows an example where the camera la is set to be a reference and the video signal is switched in every field. With reference to FIG. 3 and FIG. 4, the processing operation of the image processing device 30 will be explained.

Firstly, the control signal generator 82 sets a parameter “N” to be “0” (Step S1). Secondly, the control signal generator 82 determines whether or not the synchronization pulse is detected in the vertical synchronization signal VsyncA inputted from the reference camera 1a (Step S2). The control signal generator 82 determines a rising edge of the vertical synchronization signal VsyncA at time t1 of FIG. 3 to be the synchronization pulse (Step S2—YES). Then, the control signal generator 82 generates the control signal 2s indicative of selecting the video signal 11a corresponding to the vertical synchronization signal VsyncA of which the synchronization pulse is detected (Step S3). In such a manner, the selector 2 selects the video signal 11a to output it as the selected video signal 12.

The selected video signal 12 is stored in the region corresponding to the video signal 11a in the RAM 5 through the processing of the analog to digital converter 3 and the NTSC decoder 4. If the video signal from the camera la has already been stored, the stored video signal is updated to the new video signal. After that, the viewpoint and projection converter 6 and the combining module 7 generate the overhead view image by combining the already stored video signals inputted from the cameras 1b to 1d and the new video signal inputted from the camera 1a. The overhead view image is displayed on the LCD 10 through the LCD controller 9.

The video signals inputted from the cameras 1b to 1d used for generating the overhead view image are older than that inputted from the camera 1a. However, when the vehicle 50 goes in reverse with slow speed, for example, the difference between the older video signals and the new video signal is small. Therefore, there may be hardly problems.

On the other hand, the control signal generator 82 determines whether or not to finish selecting the video signal 11a for a field (Step S4). When the vertical synchronization signal VsyncA falls down at time t2, the control signal generator 82 determines that selecting the video signal 11a for a field is finished (Step S4—YES). Then, the control signal generator 82 generates the control signal 2s indicative of stopping selecting the video signal 11a (Step S5). Furthermore, the control signal generator 82 increments the parameter “N” by “1” (Step S6) to set the parameter “N” to be “1”.

Here, because the parameter “N” is not “4” (Step S7—NO), the control signal generator 82 determines whether or not the synchronization pulse is detected in the vertical synchronization signals VsyncB to VsyncD (Step S8). Here, the control signal generator 82 does not detect the synchronization pulse in the video signal inputted from the camera 1a, which has already been selected. That is, because the control signal generator 82 has already detected the synchronization pulse from the VsyncA inputted from the camera 1a, the control signal generator 82 does not detect the synchronization pulse from the vertical synchronization signal VsyncA at time t2′.

On the other hand, the control signal generator 82 determines that a rising edge of the vertical synchronization signal VsyncC at time t3 to be the synchronization pulse (Step S8—YES). Then, the control signal generator 82 generates the control signal 2s indicative of selecting the video signal 11c (Step S3). Thus, the selector 2 selects the video signal 11c to output it as the selected signal 12. Because the processing of the analog to digital converter 3 and so on is similar to the above, the explanation will be omitted.

After that, when the vertical synchronization signal VsyncC falls down, the control signal generator 82 determines that selecting the video signal 11c for a field is finished (Step S4—YES), to generate the control signal 2s indicative of stopping selecting the video signal 11c (Step S5). Furthermore, the control signal generator 82 increments the parameter “N” by “1” (Step S6) to set the parameter “N” to be “2”.

Here, because the parameter “N” is not “4” (Step S7—NO), the processings of Steps S8, S3 to S7 are repeated. That is, the video signal 11d is selected during time t5 to t6, and the parameter “N” is set to be “3”. Then, the video signal 11b is selected during time t7 to t8, and the parameter “N” is set to be “4”.

When the parameter “N” is set to be “4” (Step S7—YES), the processing returns to Step S1, the control signal generator 82 sets the parameter “N” to be “0” (Step S1), the control signal generator 82 determines whether or not the synchronization pulse is detected in the vertical synchronization signal VsyncA inputted from the reference camera la (Step S2) if the video signal is continuously inputted (Step S9—YES). When the synchronization pulse is detected at time t9 (Step S2—YES), the control signal generator 82 generates the control signal 2s indicative of selecting the video signal 11a again. Then, the above processing is repeated.

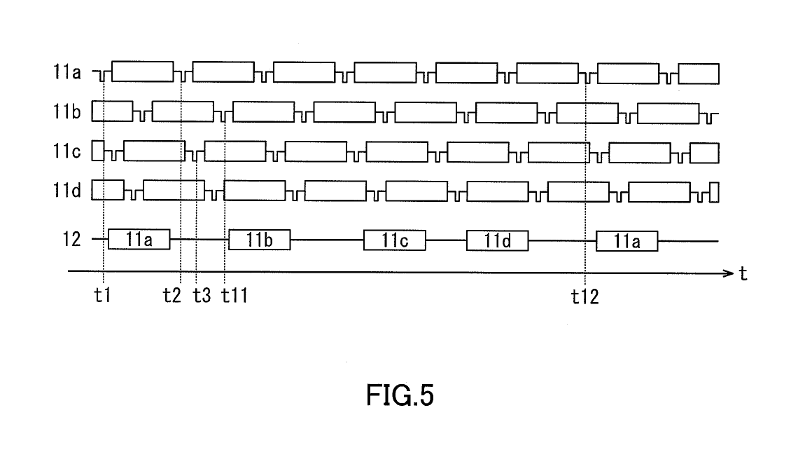

In such a manner, the video signals 11a to 11d inputted from all of the cameras 1a to 1d are selected in the period corresponding to five fields of the reference camera 1a (time t1 to t9), and the operation of one cycle of the control signal generator 82 is finished. FIG. 5 is a timing chart showing an example of the video signals 11a to 11d and the selected video signal 12 when the controller 8 is not provided. When the controller 8 is not provided, the order of the synchronization pulses inputted from the cameras 1a to 1d is not known. Therefore, the video signals 11a to 11d have to be always selected in the constant order.

FIG. 5 shows an example where the video signals are selected in the order of the cameras 1a, 1b, 1c and 1d. After finishing selecting the video signal 11a at time t2, the video signal 11b starts to be selected at time t11, which is later than time t3, when the synchronization pulse is detected from the vertical synchronization signal VsyncB. When the video signals 11a to 11d are selected in this order, it needs a period corresponding to six fields (time t1 to t12), which is longer than FIG. 3, to finish selecting the video signals 11a to 11d inputted from all of the cameras 1a to 1d.

As the period for finishing selecting all of the video signals 11a to 11d becomes longer, the older video signal is used to generate the overhead view image. Because the cameras 1a to 1d are attached on the vehicle 50, when the vehicle 50 moves, the video signals vary. Therefore, as the overhead view image is generated using the older video signal, the quality of the overhead view image decreases. On the other hand, in the present embodiment, because it is possible to shorten the period to select all of the video signals 11a to 11d, the quality of the overhead view image improves.

As stated above, in the present embodiment, the image processing system can be implemented using the asynchronous cameras 1a to 1d, one ADC3, one NTSC decoder 4, and one RAM 5 at low cost. Furthermore, because the video signals are automatically selected in the order that the synchronization pulse is detected due to the selector 2, the video signals 11a to 11d are selected efficiency and in short time, thereby generating the high quality overhead view image.

Note that although in the above explanation, the overhead view image is generated every time the video signal is updated, the overhead view image can be generated every time all of the four video signals 11a to 11d are updated to decrease the process of the combining module 7.

### Second Embodiment

In a second embodiment, which will be explained below, the video signals 11a to 11d are selected more simply by not setting a reference camera.

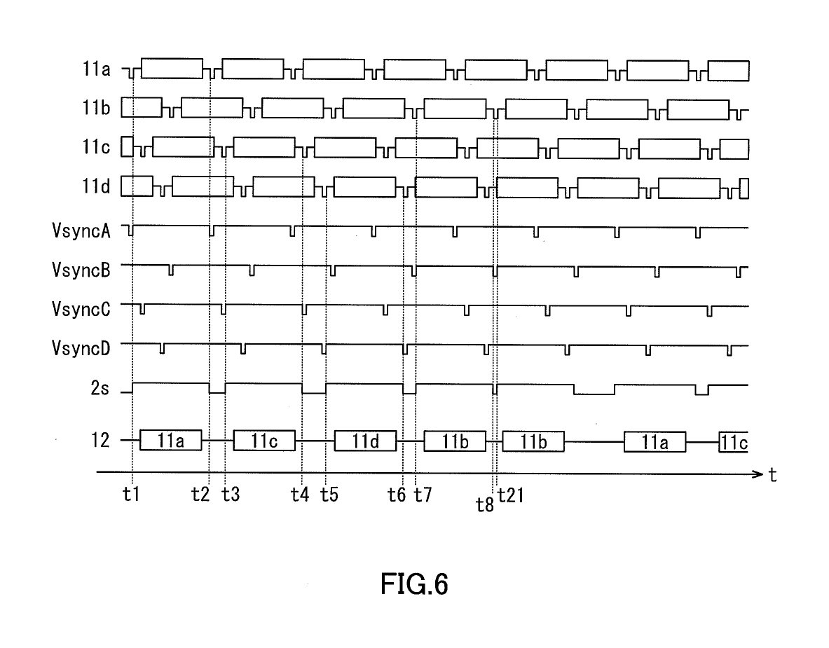

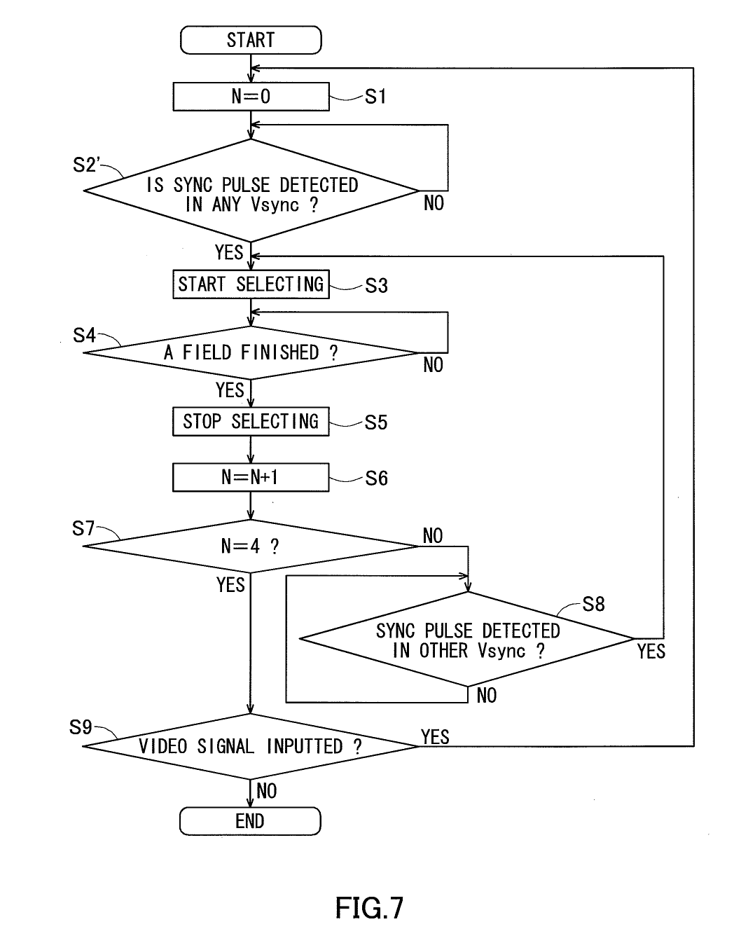

FIG. 6 is a timing chart showing an example of the video signals 11a to 11d, the vertical synchronization signals VsyncA to VsyncD, the control signal 2s and the selected video signal 12. FIG. 7 is a flowchart showing an example of the processing operation of the control signal generator 82. Hereinafter, differences from the first embodiment will be mainly described below.

Firstly, the control signal generator 82 sets the parameter “N” to be “0” (Step S1). Secondly, the control signal generator 82 determines whether or not the synchronization pulse is detected in any of vertical synchronization signals VsyncA to VsyncD (Step S2′). The control signal generator 82 determines a rising edge of the vertical synchronization signal VsyncA at time t1 of FIG. 6 to be the synchronization pulse (Step S2′—YES). Then, the control signal generator 82 generates the control signal 2s indicative of selecting the video signal 11a (Step S3). In such a manner, the selector 2 selects the video signal 11a to output it as the selected video signal 12.

After that, when the vertical synchronization signal VsyncA falls down at time t2, the control signal generator 82 determines that selecting the video signal 11a for a field is finished (Step S4—YES). Then, the control signal generator 82 generates the control signal 2s indicative of stopping selecting the video signal 11a (Step S5). Furthermore, the control signal generator 82 increments the parameter “N” by “1” (Step S6) to set the parameter “N” to be “1”.

The subsequent processing are similar to the above, and the video signal 11c is selected during time t3 to t4, and the video signal 11d is selected during time t5 to t6. Furthermore, the video signal 11b is selected during time t7 to t8, and the parameter “N” is set to be “4”.

Here, because the parameter “N” is “4” (Step S7—YES), the process returns to Step S1, and the control signal generator 82 sets the parameter “N” to be “0” (Step S1). Next, the control signal generator 82 determines whether or not the synchronization pulse is detected in any of vertical synchronization signals VsyncA to VsyncD (Step S2′).

Different from FIG. 4, when the parameter “N” is “0”, the control signal generator 82 detects the synchronization pulse not from only the reference camera, but from any of the Vsync signal VsyncA to VsyncD. Therefore, the control signal generator 82 determines that the rising edge of the vertical synchronization signal VsyncB at time t21 is the synchronization pulse (Step S2′—YES). Then, the control signal generator 82 generates the control signal 2s indicative of selecting the video signal 11b corresponding to the vertical synchronization signal VsyncB of which this synchronization pulse is detected. The following operation is similar to that of the first embodiment.

As shown in FIG. 6, it needs a period corresponding to approximately four fields (time t1 to t21) to finish selecting the video signals 11a to 11d inputted from all of the cameras 1a to 1d as a cycle. Therefore, the synchronization pulse of next selected video signal earlier, and the period becomes shorter than that of the first embodiment.

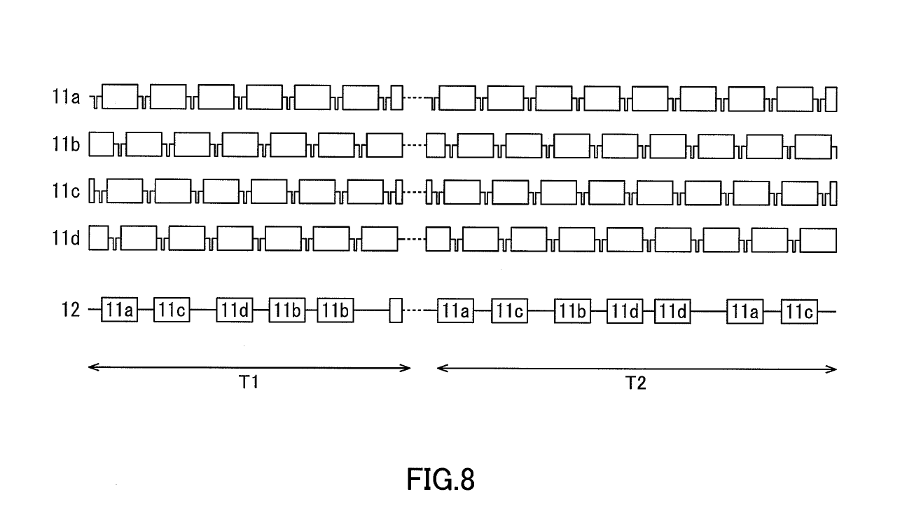

FIG. 8 is a timing chart showing another example of the video signals 11a to 11d and the selected video signal 12. A frequency of the vertical synchronization signal is not strictly 60 Hz, and the vertical synchronization signal of a part of the cameras may be disturbed due to some reason. In these cases, the phases of the synchronization pulses may shift, and the order of the synchronization pulse to appear may be change.

During term T1 of FIG. 8, the synchronization pulses appear in the order of the camera 1a, 1c, 1d and 1b. On the other hand, during term T2, the synchronization pulses appear in the order of the camera 1a, 1c, 1b and 1d. If the order of the synchronization pulse to appear changes like this, the period for the video signals 11a to 11d to be selected does not increase because the controller 8 selects the video signal automatically according to the order that the synchronization pulse is detected.

As stated above, in the second embodiment, the four video signals 11a to 11d are switched and selected without setting the reference camera. Therefore, it is possible to select the video signals 11a to 11d in shorter period than the first embodiment, thereby further improving the quality of the overhead view image.

### Third Embodiment

In the first and the second embodiments, any four video signals are selected in a cycle. On the other hand, in a third embodiment, which will be explained below, a video signal number corresponding to the selected video signal is stored in an internal memory, and the video signal whose video signal number is not stored is selected in the same cycle.

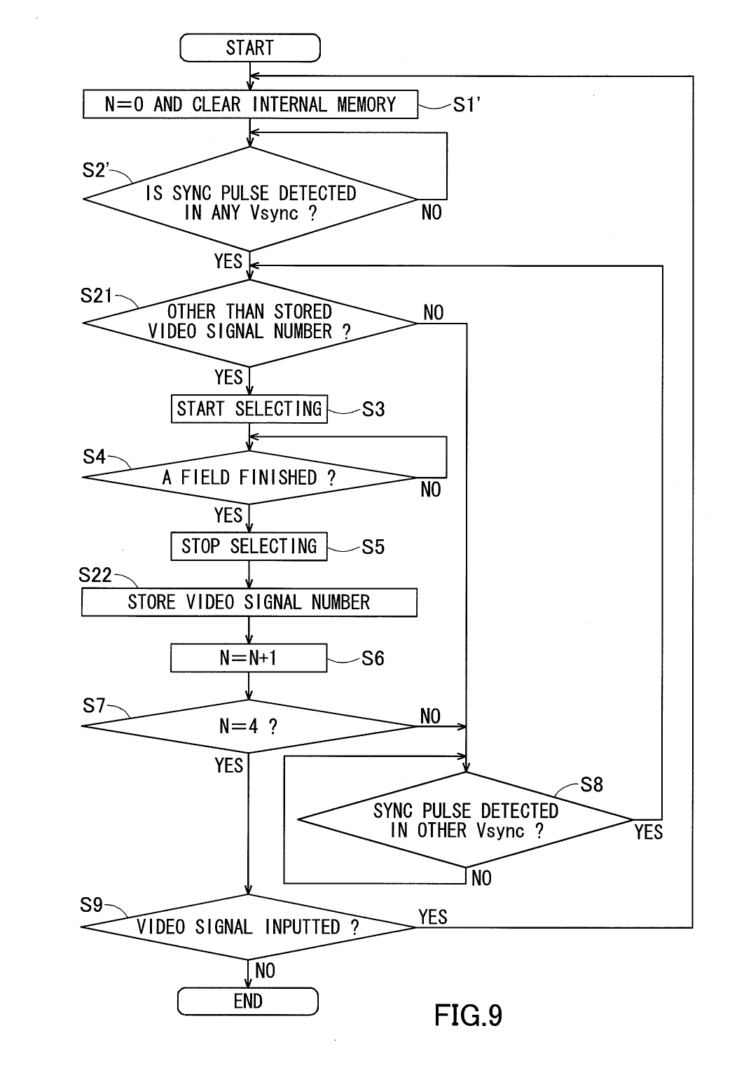

FIG. 9 is a flowchart showing an example of the processing operation of the control signal generator 82. In the following, differences from the second embodiment will be mainly described with reference to FIG. 6 and FIG. 9. The control signal generator 82 sets the parameter “N” to be “0” and clears an internal memory (not shown, Step S1′). The internal memory is configured to store video signal numbers (identifier) corresponding to each of the video signals. In the following, the video signal numbers of the video signals 11a to 11d are set to be “11a” to “11d”, respectively.

After that, the synchronization pulse on the vertical synchronization signal VsyncA inputted from the camera la is detected at time t1 of FIG. 6 (Step S2′—YES). Here, because the video signal number “11a” corresponding to the video signal 11a is not stored in the internal memory (Step S21—YES), the control signal generator 82 generates the controls signals 2s indicative of selecting the video signal 11a during time t1 to t2 (Step S3 to S5). Furthermore, the internal memory in the control signal generator 82 stores the video signal number “11a” (Step S22).

Next, the control signal generator 82 increments the parameter “N” by “1” (Step S6) to set the parameter “N” to be “1”. Because the parameter “N” is not “4” (Step S7—NO), the processing proceeds to Step S8. The synchronization pulse on the vertical synchronization signal VsyncC inputted from the camera 1c is detected at time t3 (Step S8—YES). Here, the internal memory stores only the video signal number “11a” and does not store the video signal number “11c” (Step S21—YES). Therefore, the control signal generator 82 generates the control signal 2s indicative of selecting the video signal 11c during time t3 to t4 (Step S3 to S5). After that, the internal memory further stores the video signal number “11c” (Step S22), and the parameter “N” is set to be “2” (Step S6).

By the similar subsequent processing, during time t5 to t6, the video signal 11d is selected, the video signal number “11d” is further stored in the internal memory, and the parameter “N” is set to be “3”.

Furthermore, during time t7 to t8, the video signal 11b is selected, the video signal number “11b” is further stored in the internal memory, and the parameter “N” is set to be “4”. Here, because the parameter “N” is “4” (Step S7—YES), selecting the video signals 11a to 11d inputted from all of the camera 1a to 1d is finished, and if the video signal is continuously inputted (Step S9—YES), the processing returns to Step S1′.

It is assumed that the synchronization pulse is detected from the vertical synchronization signal VsyncA at time t7, different from FIG. 6 (Step S8). Because the frequencies of the vertical synchronization signals of the cameras 1a to 1d do not strictly accord with each other, the order of the synchronization pulse may change. In this case, the internal memory has already stored the video signal number “11a” (Step S21—NO). Therefore, the video signal 11a is not selected.

At time t7, the internal memory stores the video signal numbers “11a”, “11c” and “11d” and does not store the video signal number “11b”. Therefore, until the synchronization pulse is detected from the vertical synchronization signal VsyncB, the video signals 11a, 11c and 11d are not newly selected.

As stated above, in the third embodiment, the video signal number of the already selected video signal is stored, and the video signal inputted from the already selected camera is not selected. Therefore, if the order of the synchronization pulse changes, it is possible to surely select the video signals 11a to 11d inputted from the cameras la to ld in a cycle without duplication. As a result, when the frequencies of the vertical synchronization signals do not strictly accord with each other, the quality of the overhead view image improves.

### Fourth Embodiment

A fourth embodiment, which will be explained below, specifically describes internal configurations of the selector 2 and the control signal generator 82 described in the third embodiment.

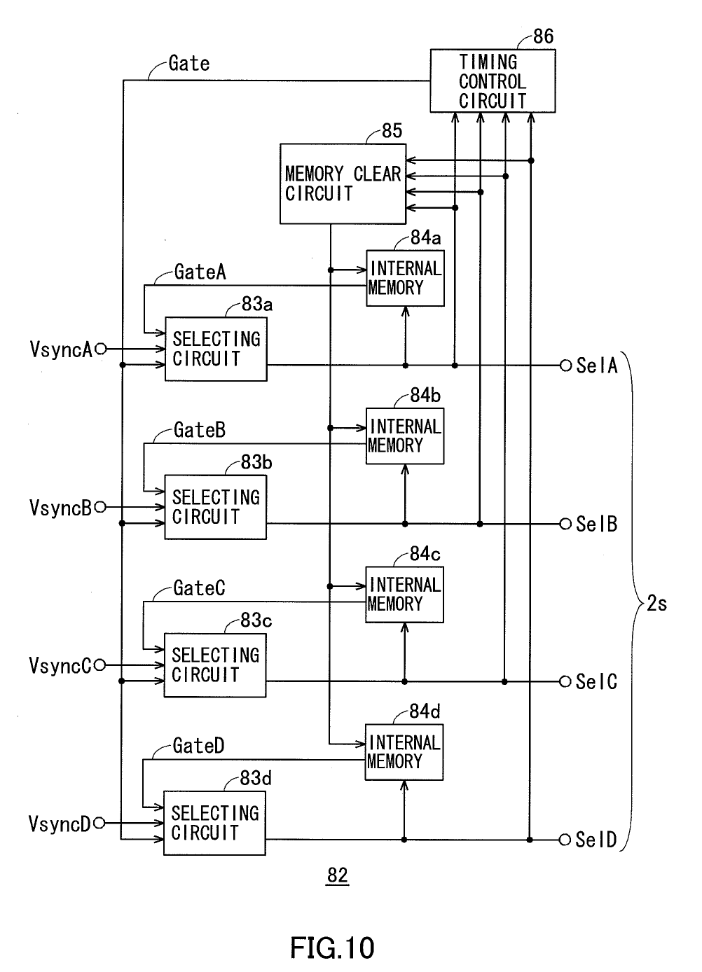

FIG. 10 is a schematic configuration showing an example of an internal configuration of the control signal generator 82. The control signal generator 82 has selecting circuits 83a to 83d, internal memories 84a to 84d, a memory clear circuit 85 and a timing control circuit 86.

The selecting circuit 83a generates a control signal SelA based on the vertical synchronization signal VsyncA, a timing control signal (third control signal) Gate, a duplication prevention signal (second control signal) GateA. The selecting circuits 83b to 83d are similar to the selecting circuits 83a. The control signals SelA to SelD correspond to the control signal 2s of FIG. 1. The internal memory 84a stores that the video signal 11a has been selected. Then, the internal memory 84a generates the duplication prevention signal GateA so as not to select the video signal 11a twice in a cycle. The internal memories 84b to 84d are similar to the internal memory 84a.

The memory clear circuit 85 clears information stored in the internal memories 84a to 84d after finishing all of the video signals 11a to 11d according to the control signals SelA to SelD. The timing control circuit 86, based on the control signals SelA to SelD, generates the control signal Gate so that the control signals SelA to SelD do not change before finishing selecting the video signal for one field.

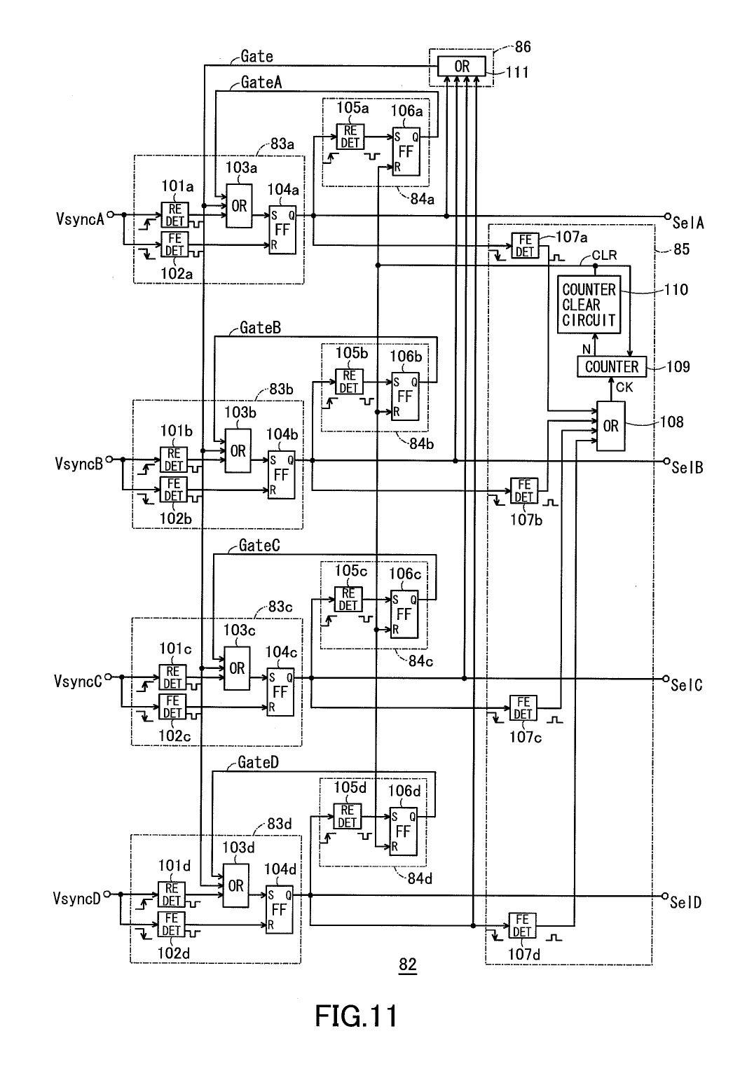

FIG. 11 is a circuit block diagram showing an example of the more detailed internal configuration of the control signal generator 82. Because the internal configurations of the selecting circuits 83a to 83d and those of the internal memories 84a to 84d are the same respectively, the selecting circuit 83a and the internal memory 84a will be explained hereinafter, as a representative. The selecting circuit 83a in the control signal generator 82 has a rising edge detecting circuit (RE DET) 101a, a falling edge detecting circuit (FE DET) 102a, an OR circuit 103a and a flip-flop 104a.

The rising edge detecting circuit 101a generates a low pulse in synchronization with a rising edge of the vertical synchronization signal VsyncA to provide the output signal thereof to the OR circuit 103a. The falling edge detecting circuit 102a generates a low pulse in synchronization with a falling edge of the vertical synchronization signal VsyncA to provide the output signal thereof to a reset terminal “R” of the flip-flop 104a. The OR circuit 103a performs OR operation of the timing control signal Gate, the duplication prevention signal GateA and the output signal of the rising edge detecting circuit 101a to provide the result to a set terminal “S” of the flip-flop 104a.

The flip-flop 104a sets the control signal SelA to be high from an output terminal Q when the low pulse is provided to the set terminal “S”, and sets the control signal SelA to be low when the low pulse is provided to the reset terminal “R”. That is, if both the timing control signal Gate and the duplication prevention signal GateA are low, the flip-flop 104a sets the control signal SelA to be high in synchronization with the rising edge of the vertical synchronization signal VsyncA. Furthermore, the flip-flop 104a sets the control signal SelA to be low in synchronization with the falling edge of the vertical synchronization signal VsyncA.

The internal memory 84a has a rising edge detecting circuit 105a and a flip-flop 106a.

The rising edge detecting circuit 105a generates a low pulse in synchronization with a rising edge of the control signal SelA to provide the output signal thereof to a set terminal “S” of the flip-flop 106a.

The operation of the flip-flop 106a is similar to that of the flip-flop 104a. When the low pulse is provided to the set terminal “S” from the rising edge detecting circuit 105a, the flip-flop 106a sets the duplication prevention signal GateA to be high from an output terminal “Q”. This corresponds to storing the video signal number “11a” in the internal memory 84a. Furthermore, when the low pulse is provided to the reset terminal “R” from the memory clear circuit 85, the flip-flop 106a sets the duplication prevention signal GateA to be low. This corresponds to clearing the video signal number “11a” stored in the internal memory 84a.

The duplication prevention signal GateA is provided to the OR circuit 103a in the selecting circuit 83a. Therefore, when the duplication prevention signal GateA is high, the output signal of the OR circuit 103a is fixed to be high, and the low pulse is not generated on the set terminal “S” of the flip-flop 104a. As a result, when the duplication prevention signal GateA is set to be high, the control signal SelA is not set to be high.

The memory clear circuit 85 has falling edge detecting circuits 107a to 107d, an OR circuit 108, a counter 109 and a counter clear circuit 110. The falling edge detecting circuits 107a to 107d generate high pulses in synchronization with rising edges of the control signals SelA to SelD, respectively. The OR circuit 108 performs OR operation of the output signals of the falling edge detecting circuits 107a to 107d. Therefore, when any of the control signals SelA to SelD falls down, the OR circuit 108 generates a high pulse on an output signal CK in synchronization therewith to provide the output signal CK to the counter 109.

The counter 109 increments a count value “N” by “1” when the high pulse is inputted and provides the count value “N” to the counter clear circuit 110. The counter clear circuit 110 generates a low pulse on a clear signal CLR when the count value “N” becomes “4”. In synchronization with the low pulse on the clear signal CLR, the counter 109 sets the count value “N” to be “0”. Furthermore, the clear signal CLR is also provided to the flip-flops 106a to 106d in the internal memories 84a to 84d, respectively. In synchronization with the low pulse on the clear signal CLR, the flip-flops 106a to 106d set the duplication prevention signals GateA to GateD to be low, respectively.

The timing control circuit 86 has an OR circuit 111. The OR circuit 111 performs OR operation of the control signals SelA to SelD to generate the timing control signal Gate. The timing control signal Gate is provided to the OR circuits 103a to 103d in the selecting circuits 83a to 83d, respectively. When any of the control signals SelA to SelD is high, the timing control signal Gate, which is generated by the OR circuit 111, is fixed to be low, and the low pulse is not generated on the set terminal “5” of the flip-flop 104a. Therefore, when any of the control signals SelA to SelD is high and while the video signal for one field is selected, the control signals SelA to SelD do not change.

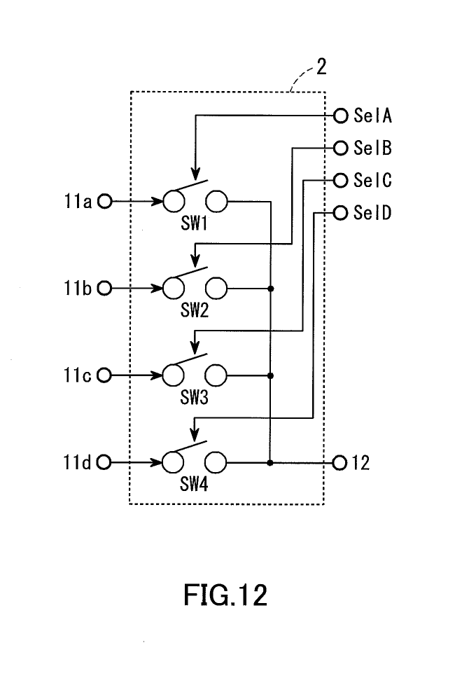

FIG. 12 is a schematic diagram showing an example of an internal configuration of the selector 2. The selector 2 has switches SW1 to SW4. Switches SW1 to SW4 turn on when the control signals SelA to SelD is high respectively and turn off when the control signals SelA to SelD is low, respectively.

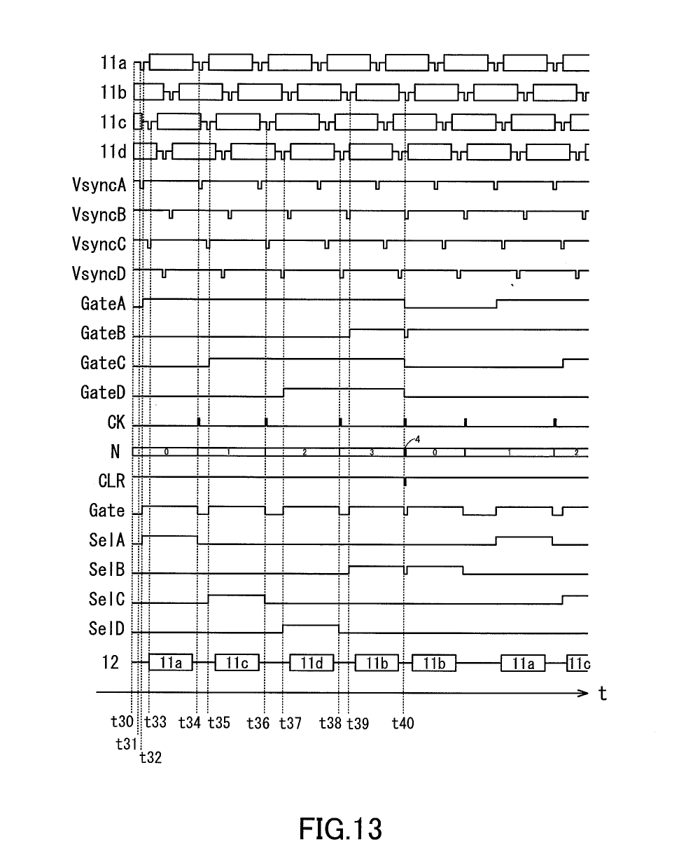

FIG. 13 is a timing chart showing signal waveforms of each part of the selector 2 and the control signal generator 82. The processing operation of the control signal generator 82 of FIG. 11 and that of the selector 2 of FIG. 2 will be explained in detailed with reference to the flowchart of FIG. 9.

At time t30, it is assumed that the timing control signal Gate, the duplication prevention signals GateA to GateD and control signals SelA to SelD are low, and the count value “N” is “0” (Step S1′). When the vertical synchronization signal VsyncA falls down at time t31, the falling edge detecting circuit 102a generates the low pulse. However, the control signal SelA generated by the flip-flop 104a stays in low.

When the vertical synchronization signal VsyncA rises up at time t32, the rising edge detecting circuit 101a generates the low pulse (Step S2′—YES). Because the timing control signal Gate and the duplication prevention signal GateA are low (Step S21—YES), the OR circuit 103a also generates the low pulse. In synchronization therewith, the flip-flop 104a sets the control signal SelA to be High (Step S3). Therefore, the switch SW1 turns on, and the video signal 11a is selected.

When the controls signal SelA rises up at time t32, the rising edge detecting circuit 105a generates the low pulse. As a result, the flip-flop 106a sets the duplication prevention signal GateA to be high (Step S22). Accordingly, the output signal of the OR circuit 103a is set to be high.

On the other hand, because the control signal SelA is set to be high, the OR circuit 111 sets the timing control signal Gate to be high. As a result, the output signals of the OR circuits 103b to 103d are set to be high. For example, when the vertical synchronization signal VsyncC rises up at time t33, the rising edge detecting circuit 101c generates the low pulse. However, because the output signal of the OR circuit 103c is fixed to be high, the high pulse is not generated on the set terminal “S” of the flip-flop 104c. Therefore, the flip-flop 104 does not set the control signal SelC to be high.

Thus, while any of the control signals SelA to SelD is high, the OR circuit 111 sets the timing control signal Gate to be high. Therefore, two or more of the control signals SelA to SelD are not set to be high at the same time, and the control signals do not change before finishing the video signal for one field.

When the vertical synchronization signal VsyncA falls down at time t34, the falling edge detecting circuit 102a generates the low pulse (Step S4—YES). In synchronization therewith, the flip-flop 104a sets the control signal SelA to be low (Step S5). By such a manner, the video signal 11a for one field is finished. When the control signal SelA falls down at time t34, the falling edge detecting circuit 107a in the memory clear circuit 85 generates the high pulse. Because the output signals of the other falling edge detecting circuits 107b to 107d are low, the OR circuit 108 generates the high pulse on the output signal CK in synchronization with the high pulse of the falling edge detecting circuit 107a. In this way, the counter 109 increments the count value “N” by “1” (Step S6) to set the count value “N” to be “1”. Because the operations of the selecting circuits 83b to 83d are similar to that of the selecting circuit 83a, the following explanation will be simplified.

When the vertical synchronization signal VsyncC rises up at time t35, the flip-flop 104c sets the control signal SelC to be high. Furthermore, when the vertical synchronization signal VsyncC falls down at time t36, the flip-flop 104c sets the control signal SelC to be low. In synchronization with the falling edge of the control signal SelC, the counter 109 increments the count value “N” by “1” to set the count value “N” to be “2”.

When the vertical synchronization signal VsyncD rises up at time t37, the flip-flop 104d sets the control signal SelD to be high. Furthermore, when the vertical synchronization signal VsyncD falls down at time t38, the flip-flop 104d sets the control signal SelD to be low. In synchronization with the falling edge of the control signal SelD, the counter 109 increments the count value “N” by “1” to set the count value “N” to be “3”.

When the vertical synchronization signal VsyncB rises up at time t39, the flip-flop 104b sets the control signal SelB to be high. Furthermore, when the vertical synchronization signal VsyncB falls down at time t40, the flip-flop 104b sets the control signal SelB to be low. In synchronization with the falling edge of the control signal SelB, the counter 109 increments the count value “N” by “1” to set the count value “N” to be “4”.

Because the count value “N” becomes “4” (Step S7—YES), the counter clear circuit 110 generates the low pulse on the clear signal CLR. In synchronization with the low pulse, the flip-flops 106a to 106d set the duplication prevention signals GateA to GateD to be low respectively, and the counter 109 sets the count value “N” to be “0” (Step S1′). By the above operation, all of the video signals 11a to 11d inputted from the four cameras 1a to 1d are selected, and the operation of one cycle is completed.

Here, the duplication prevention signals GateA to GateD control the flip-flops 104a to 104d so as not select the video signal inputted from the same camera twice in one cycle. For example, the duplication prevention signal GateA is set to be high after time t32.

It is assumed that the vertical synchronization signal VsyncA inputted from the camera la at time t37, different from FIG. 13. In this case, the rising edge detecting circuit 101a in the selecting circuit 83a generates the low pulse. However, because the duplication signal GateA is high (Step S21—NO), the output signal of the OR circuit 103a is fixed to be high, and the OR circuit 103a does not generate the low pulse. Therefore, the flip-flop 104a does not set the control signal SelA to be high, and the video signal 11a is not selected.

As shown in FIG. 13, because the duplication prevention signals GateA, GateC and GateD are high, until the synchronization pulse is detected from the vertical synchronization signal VsyncB inputted from the camera 1b, the video signals 11a, 11c and 11d which are inputted from the other cameras 1a, 1c and 1d respectively, are not selected.

As stated above, in the fourth embodiment, the internal memory 84a stores that the video signal 11a has been selected, and fixes the input signal to the flip-flop 104a which generates the control signal SelA so as not to select the video signal 11a in the same cycle. Therefore, if the order of the synchronization pulse changes, it is possible to surely select the video signals 11a to 11d inputted from the four cameras 1a to 1d in a cycle without duplication. Furthermore, the timing control circuit 86 fixes the input signals to the flip-flops 104a to 104d which generate the control signal SelA to SelD respectively until the video signal for one field is finish. Accordingly, the control signals SelA to SelD do not change before finishing selecting the video signal for one filed.

### Fifth Embodiment

In the first to fourth embodiments, the video signals are switched every one field. On the other hand, it can be selected whether the video signals are switched every one field or every one frame.

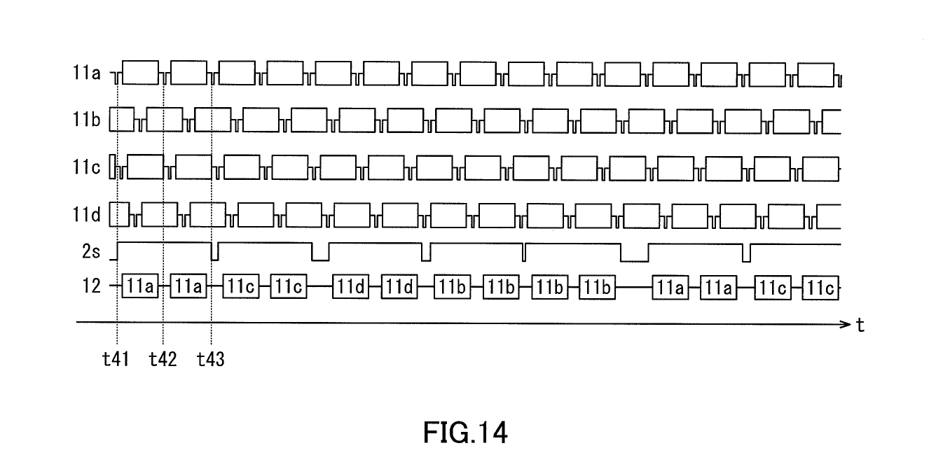

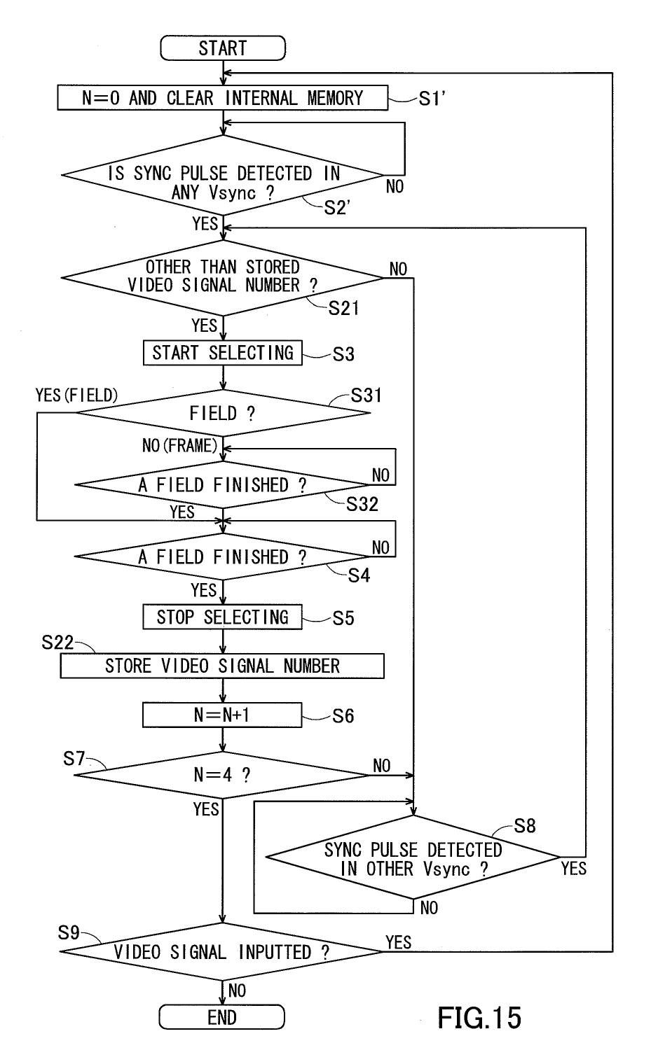

FIG. 14 is a timing chart showing an example of the video signals 11a to 11d, the control signal 2s and the selected video signal 12. FIG. 15 is a flowchart showing an example of the processing operation of the control signal generator 82. Hereinafter, differences from the third embodiment will be mainly explained. Firstly, a case will be explained where the video signals are switched every one frame. Here, the frame is composed of a field corresponding to an odd line and a field corresponding to an even line. In the case of switching the video signals every one frame, a signal indicative of switching the video signals every one frame (not shown) is inputted to the controller 8 of FIG. 1.

The synchronization pulse is detected from the vertical synchronization signal VsyncA inputted from the camera la at time t41 of FIG. 14 (Step S2′—). Here, the internal memory does not store the video signal number “11a” (Step S21—YES). Therefore, the control signal generator 82 generates the control signal 2s indicative of selecting the video signal 11a at time t41 (Step S3). Note that it does not matter whether the video signal 11a at t41 is a field corresponding to an even line or an odd line.

In a case where the video signal 11a is selected every one frame (Step S31—NO), selecting a first field is finished when the vertical synchronization signal VsyncA falls down at time t42 (Step S32—YES). Then, when the vertical synchronization signal VsyncA falls down at time t43, selecting a second filed is finished (Step S4—YES, Step S5). Thus, by selecting the video signal priori inputted, regardless of whether the video signal corresponds to the odd line or the even line, it is possible to shorten the term necessary to select one frame.

When the control signal generator 82 finishes selecting one frame, that is, two fields, the video signal number “11a” is stored in the internal memory (Step S22). The selector 2 can switch the video signal every one frame by the similar processing operation.

On the other hand, in the case of switching the video signals every one field, a signal indicative of switching the video signals every one field (not shown) is inputted to the controller 8. In this case, the processing of Step S32 is not performed, and when finishing selecting the video signal for one field, the control signal generator 82 stops selecting (Step S5). Therefore, the processing operation is the same as that shown in FIG. 9, and it is possible to switch the video signal every one field.

When a speed of the vehicle 50 of FIG. 2 on which the cameras 1a to 1d are attached is fast, the video signals changes substantially as the time advances. Therefore, it is better to switch the video signals inputted from the cameras la to ld quickly. Accordingly, when the speed of the vehicle 50 of FIG. 2 is fast, it is preferable to switch the video signals one every field.

Contrarily, when the speed is slow, the video signals change a little even though the time advances. Therefore, the video signals can be switched every one frame. Because resolution of the frame is twice as high as that of the field, it is possible to generate the overhead view image with higher quality.

Therefore, when the speed of the vehicle 50 is faster than a predetermined value, the video signal can be switched every one field, and when the speed of the vehicle 50 is slower, the video signal can be switched every one frame. The switching of the field and the frame can be performed manually or performed automatically using a speed pulse (not shown) of the vehicle 50 to determine the speed.

As stated above, in the fifth embodiment, the video signals also can be switched every frame. Therefore, by switching the video signals every frame especially when the speed of the vehicle 50 is slow, the quality of the overhead view image further improves.

Note that , although an example is explained where the video signals 11a to 11d are composite video signals in the above explained embodiments, the video signals 11a to 11d can be other format signals. For example, the video signals 11a to 11d can be signals where the vertical synchronization signals and the image data are separated in advance. In this case, the vertical synchronization signal detector 81 of FIG. 1 is unnecessary, and the vertical synchronization signal is inputted to the control signal generator 82 directly. The video signals 11a to 11d can be digital signals. In this case, the analog to digital converter 3 is unnecessary. Furthermore, by providing a PAL decoder or a SECAM decoder instead of the NTSC decoder 4, the video signals can be decoded in a format other than NTSC. Additionally, the number of the video signals is not limited to “4”.

At least a part of the image processing system explained in the above embodiments can be formed of hardware or software. When the image processing system is partially formed of the software, it is possible to store a program implementing at least a partial function of the image processing system in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc. Further, a program realizing at least a partial function of the image processing system can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An image processing device comprising:
a control signal generator configured to detect a synchronization pulse from a vertical synchronization signal in each of a plurality of video signals and configured to generate a first control signal indicative of selecting one video signal of the plurality of video signals, wherein the synchronization pulse corresponding to each video signal is detected in turn for a first period;
a selector configured to select the one video signal of the plurality of video signals according to the first control signal;
a memory configured to store the selected video signal in one region of a plurality of regions corresponding to the selected video signal in a first format; and
a combined image generator configured to generate a combined image by combining the plurality of video signals stored in the plurality of regions.

2. The device of claim 1, wherein the control signal generator is configured to store an identifier corresponding to the selected video signal, and is configured to generate the first control signal so as not to select the video signal when the identifier corresponding to the video signal is stored, wherein the video signal corresponds to the detected synchronization pulse.

3. The device of claim 1, wherein the control signal generator comprises:
a video selector configured to generate the first control signal according to the vertical synchronization signal and a second control signal; and
an internal memory configured to store an indication that the video signal has been selected according to the first control signal, wherein the video selector is configured not to select the video signal stored in the internal memory according to the second control signal.

4. The device of claim 3, wherein the control signal generator comprises a memory controller configured to clear the internal memory when all of the plurality of video signals have been selected according to the first control signal.

5. The device of claim 3, wherein the control signal generator comprises a timing controller configured to generate a third control signal,
wherein the video selector is configured not to change the first control signal during the first period, according to the third control signal.

6. The device of claim 5, wherein the video selector comprises:
a rising edge detector configured to detect a rising edge of the vertical synchronization signal;
an AND gate configured to generate a set signal according to an output signal of the rising edge detecting circuit, the second control signal and the third control signal;
a falling edge detector circuit configured to generate a reset signal when detecting a falling edge of the vertical synchronization signal; and
a flip-flop configured to generate the first control signal in synchronization with the set signal and the reset signal.

7. The device of claim 1, wherein the first period corresponds to a period of a field or a frame of the video signal for which the synchronization pulse is detected.

8. The device of claim 1, wherein the memory is configured to store the selected video signal by determining the region corresponding to the selected video signal based on the first control signal.

9. The device of claim 1, wherein the combined image generator is configured to generate the combined image every time one of the plurality of video signals stored in the memory is updated.

10. The device of claim 1, wherein the combined image generator is configured to generate the combined image every time all of the plurality of video signals stored in the memory are updated.

11. An image processing system comprising:
a plurality of cameras;
a control signal generator configured to detect a synchronization pulse from a horizontal synchronization signal in each of a plurality of video signals inputted from the plurality of cameras and configured to generate a first control signal indicative of selecting the plurality of video signals, wherein the synchronization pulse corresponding to each video signal is detected in turn for a first period;
a selector configured to select the one video signal of the plurality of video signals according to the first control signal;
a memory configured to store the selected video signal in one region of a plurality of regions corresponding to the selected video signal in a first format; and
a combined image generator configured to generate a combined image by combining the plurality of video signals stored in the plurality of regions.

12. The system of claim 11 further comprising a display configured to display the combined image.

13. The system of claim 11, wherein the control signal generator is configured to store an identifier corresponding to the selected video signal, and is configured to generate the first control signal so as not to select the video signal when the identifier corresponding to the video signal is stored, wherein the video signal corresponds to the detected synchronization pulse.

14. The system of claim 11, wherein the control signal generator comprises:
a video selector configured to generate the first control signal according to the vertical synchronization signal and a second control signal; and
an internal memory configured to store an indication that the video signal has been selected according to the first control signal,
wherein the video selector is configured not to select the video signal stored in the internal memory according to the second control signal.

15. The system of claim 14, wherein the control signal generator comprises a timing controller configured to generate a third control signal,
wherein the video selector is configured not to change the first control signal during the first period, according to the third control signal, and
wherein the video selector comprises:
a rising edge detector configured to detect a rising edge of the vertical synchronization signal;
an AND gate configured to generate a set signal according to an output signal of the rising edge detecting circuit, the second control signal and the third control signal;
a falling edge detector configured to generate a reset signal when detecting a falling edge of the vertical synchronization signal; and
a flip-flop configured to generate the first control signal in synchronization with the set signal and the reset signal.

16. The system of claim 11, wherein the first period corresponds to a period of a field or a frame of the video signal for which the synchronization pulse is detected.

17. The system of claim 16, wherein the plurality of cameras are attached to a vehicle, and the first period comprises the period of the field or the frame according to a speed of the vehicle.

18. The system of claim 11, wherein the memory is configured to store the selected video signal by determining the region corresponding to the selected video signal based on the first control signal.

19. The system of claim 11, wherein the combined image generator is configured to generate the combined image every time one of the plurality of video signals stored in the memory is updated.

20. The system of claim 11, wherein the combined image generator is configured to generate the combined image every time all of the plurality of video signals stored in the memory are updated.
